(19) United States
(12) Patent Application Publication
(10) Pub. No.: US 2022/0412503 A1
(43) Pub. Date: Dec. 29, 2022

(54) BRACKET FOR SECURING VERTICALLY EXTENDING ELEMENTS

(71) Applicant: Trellisk Products Ltd., North Vancouver (CA)

(72) Inventor: Cornelia UNGER, North Vancouver (CA)

(21) Appl. No.: 17/837,675

(22) Filed: Jun. 10, 2022

(30) Foreign Application Priority Data
Jun. 25, 2021 (CA) 3123431

(51) Int. Cl. F16M 11/16; F16B 7/04

(52) U.S. Cl. CPC F16M 11/16; F16B 7/0486

(57) ABSTRACT

A bracket for supporting a plurality of vertically extending supports is provided. The bracket has an outer housing and an internal support. The internal support is receivable within the outer housing, and the outer housing and the internal support together define a plurality of channels. Each one of the plurality of channels is shaped and configured to receive a free end of a corresponding one of the plurality of vertically extending supports.

### CROSS-REFERENCE TO RELATED APPLICATIONS

This application claims priority to Canadian patent application No. 3123431 filed 25 Jun. 2021, the entirety of which is incorporated by reference herein for all purposes.

### TECHNICAL FIELD

Some embodiments relate to apparatus for securing vertically or generally vertically extending members. Some embodiments relate to a bracket for securing vertically or generally vertically extending members.

### BACKGROUND

There is a general desire to provide an improved support for securing vertically extending elements to form a trellis, obelisk or other vertical structure. Such structures may have potential utility as plant supports (e.g. for supporting the growth of a climbing vine), for decorative or screening purposes, to form an arbor, as shelving units or to support growing shelves, as plant stands or supports, as towel, clothing or accessory racks, as retail display units, and/or as supports for lighting or the like.

Existing vertical supports that are pre-assembled are bulky and heavy, making shipping difficult and making it difficult for customers to purchase and easily transport such supports. Kits for assembling such vertical supports are available, but still include bulky components such as lattice or pre-cut pieces and so are still bulky to ship. Such kits are not easy to use, and considerable difficulty is presented to the end user attempting to assemble the finished structure. A certain amount of skill and an investment of considerable time may be required to assemble a structure from such a kit. Such kits are also generally sold in only one size and configuration, so that customization is not possible.

There remains a need for improved systems for easily assembling and securing vertically extending supports.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect provides a bracket for supporting a plurality of vertically extending supports. The bracket has an outer housing and an internal support. The internal support is receivable within the outer housing and the outer housing and the internal support together define a plurality of channels, each one of the plurality of channels being shaped and configured to receive a free end of a corresponding one of the plurality of vertically extending supports.

Another aspect provides a bracket for supporting a plurality of vertically extending supports, the bracket having a plurality of channels. Each one of the plurality of channels is shaped and configured to receive a free end of a corresponding one of the plurality of vertically extending supports.

Another aspect provides a vertical structure having a plurality of vertically extending supports and a bracket as described herein, a free end of each one of the vertically extending supports being received in a corresponding channel of the bracket.

Another aspect provides a method of assembling a vertical structure as described herein. A free end of each one of a plurality of vertically extending supports is inserted into a corresponding channel of a bracket as described herein.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows an example embodiment of a trellis assembled using an example embodiment of a bracket.

FIG. 2 shows a second example embodiment of a trellis assembled using an example embodiment of a bracket, the trellis having no horizontal supports.

FIG. 3 shows a perspective exploded view of an example embodiment of a bracket.

FIG. 4 shows a bottom view of the example embodiment of FIG. 3 in an assembled configuration.

FIG. 5A shows a cross-sectional view of the example embodiment of FIG. 3 taken through line A-A of FIG. 4. FIG. 5B shows a cross-sectional view of a second example embodiment that omits a spacing protrusion.

FIG. 6 shows a perspective view of an example embodiment of an internal support of a bracket.

FIG. 7 shows a bottom view of a further example embodiment of a bracket.

FIG. 8 shows a top view of an example embodiment of a bracket with vertically extending supports inserted in the channels thereof.

FIG. 9 shows an example embodiment of a method of assembling a vertical structure using a bracket.

FIG. 10 shows an example embodiment of a trellis having a decorative fence post cap affixed thereto.

FIG. 11 shows an example embodiment of a trellis assembled using vertically extending supports of different lengths.

FIG. 12 shows an example embodiment of a bracket having a hanger for supporting a structure hanging off the bracket.

FIG. 13 shows the embodiment of FIG. 12 being used to form a trellis adapted to support a planter from the bracket, the planter hanging vertically within the trellis.

FIG. 14 shows an example embodiment of a structure made by the interconnection of two trellises.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The inventor has now created an improved bracket for assembling a plurality of vertical elements into a structure such as a trellis or an obelisk. In some embodiments, the vertical elements are pieces of dimensional lumber.

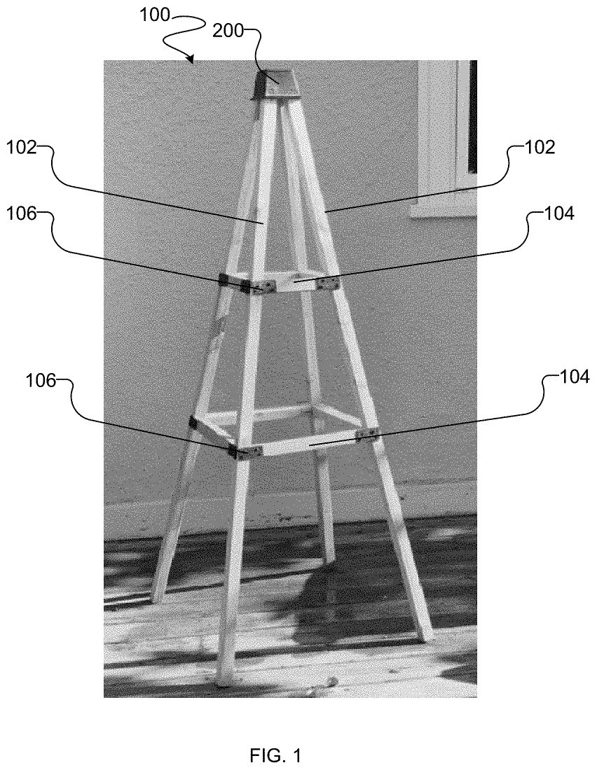

With reference to FIG. 1, an example embodiment of a trellis 100 assembled using bracket 200 is illustrated. Trellis 100 has a plurality of vertically or generally vertically extending supports 102, and a plurality of horizontal supports 104 secured in place using side brackets 106. Any suitable fastener or component capable of engaging vertically extending supports 102 with horizontal supports 104 can be used to provide side bracket 106, including suitable fasteners such as nails, screws or the like.

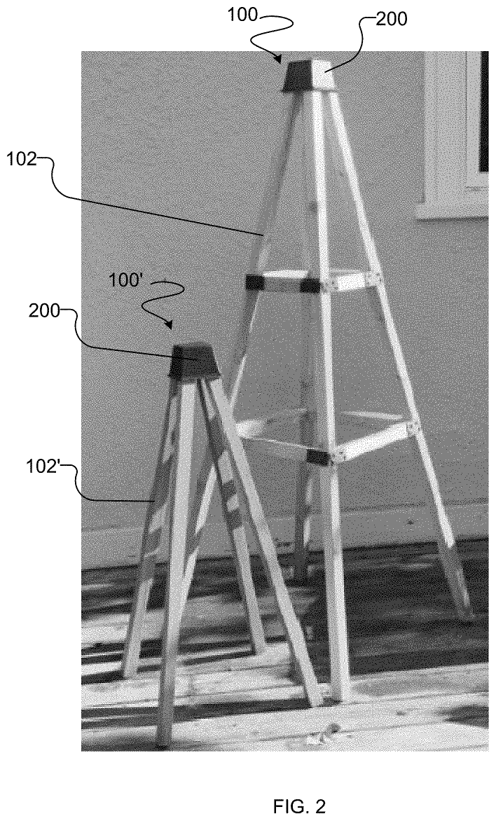

With reference to FIG. 2, in some embodiments such as trellis 100′, horizontal supports 104 can be omitted and only vertically extending supports 102′ are used to assemble trellis 100′ using bracket 200.

In the illustrated embodiments, trellis 100 and trellis 100′ have four vertically extending supports 102/102′. In alternative embodiments, any desired number of vertically extending supports 102/102′ can be provided, e.g. 3, 5, 6, 7, 8, 9, 10, 11, 12 or more. As used herein, a reference to vertically extending support 102 includes reference to vertically extending support 102′. To provide a symmetrical structure, the lengths of each one of vertically extending supports 102 should be equal or approximately equal in length. In alternative embodiments, the lengths of vertically extending supports 102 can be of different lengths to accommodate a slope, step or other change in configuration of the ground on which trellis 100 will sit.

Any suitable components can be used to provide vertically extending supports 102, for example pieces of plastic, metal, wood, sticks or branches, or the like. In some embodiments vertically extending supports 102 are pieces of dimensional lumber, e.g. a piece of 1×1 or 1×2 or 2×2 dimensional lumber, including any combination of different dimensions of lumber as may be desired (e.g. two 1×1 sized vertically extending supports could be combined with one 1×2 and one 2×2 vertically extending support); and/or multiple pieces of lumber having different dimensions can be used to make one single vertically extending support 102 (e.g. two 1×1 pieces of lumber could be stacked together to effectively yield a 1×2 vertically extending support); or the like. The actual size of dimensional lumber is slightly smaller than its nominal size, so for example the dimensions of a 1×1 piece of dimensional lumber are actually ¾″ by ¾″, of a 1×2 piece of dimensional lumber are actually ¾″ by 1½″, and of a 2×2 piece of dimensional lumber are actually 1½″ by 1½″, for example. The dimensions provided herein are exemplary only, and the person skilled in the art will recognize that different dimensions can be used for the various components described herein.

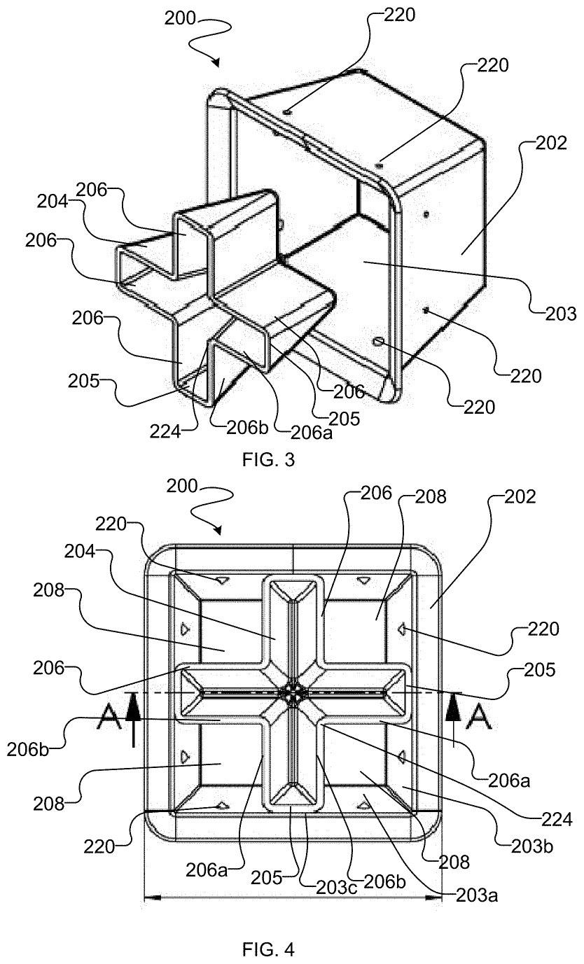

With reference to FIGS. 3, 4, 5A and 6, an example embodiment of a bracket 200 is illustrated in more detail. Bracket 200 has a housing 202 and an internal support 204 which is slideable into housing 202. Housing 202 has an internal surface 203.

Internal support 204 is formed to provide a plurality of support arms 206. When internal support 204 is inserted within housing 202, as shown in FIG. 4, a channel 208 for receiving vertically extending supports 102 is formed between each adjacent pair of support arms 206. More specifically, each adjacent pair of support arms 206 can be described as two adjacent support arms 206a and 206b that are joined together by an inner edge 224. Each one of support arms 206a and 206b is opposed from a corresponding portion 203a and 203b of interior surface 203 of housing 202. Support arm 206a is opposite to, spaced apart from, and extends generally parallel to portion 203a of housing 202. Support arm 206b is opposite to, spaced apart from, and extends generally parallel to portion 203b of housing 202. Together, support arms 206a, 206b and portions 203a, 203b of housing 202 define channel 208.

Between each neighbouring pair of support arms 206 is a connection surface 205, which makes contact with and can be secured or otherwise adhered to the internal surface 203 of housing 202 in any suitable manner. More specifically and with reference to FIG. 4, connection surface 205 extends between one support arm 206a of a first pair of support arms 206 and a second support arm 206b of a second pair of support arms 206.

Connection surface 205 extends parallel to and is in contact with the corresponding portion 203c of the internal surface of housing 202 so that connection surface 205 can be adhered to the corresponding portion 203c of the internal surface 203 of housing 202.

In alternative embodiments, housing 200 and internal support 204 could be integrally formed, for example by injection molding or in any other suitable manner.

In the illustrated embodiment, housing 202 is generally cubically shaped to receive internal support 204, and internal support 204 defines four channels 208 therein. Each of the four channels 208 is generally rectangularly and/or squarely shaped, which makes bracket 200 particularly suited for slideably receiving vertically extending supports 102 that are in the form of dimensional lumber (i.e. having a generally square or rectangular cross-section). In alternative embodiments, channels 208 could be provided with other shapes, e.g. having a triangular, pentagonal, hexagonal, heptagonal, octagonal or the like shape, so long as vertically extending supports 102 used with such bracket 200 are provided with a corresponding cross-sectional shape so that vertically extending supports 102 can be slideably received into channels 208.

The illustrated embodiment of bracket 200 is adapted for use with three or four vertically extending supports 102. In alternative embodiments, the number of vertically extending supports 102 with which bracket 200 can be used can be varied by varying the number of channels formed by internal support 204, for example by forming three channels for a structure incorporating three vertically extending supports 102, five channels for a structure incorporating five vertically extending supports 102 (although a user could choose to use only three or four vertically extending supports with such a bracket if desired), six channels for a structure incorporating six vertically extending supports 102 (although a user could choose to use only three, only four, or only five vertically extending supports with such a bracket if desired), and so on where the number of channels provided in bracket 200 represents the maximum number of vertically extending supports 102 that can be used with such bracket.

A variety of options can be used to secure vertically extending supports 102 in place within bracket 200 to form trellis 100 or 100′. In some embodiments, no form of additional securement is used, and the gripping forces provided by the flexibility of the material from which bracket 200 is made and/or the relative angles of orientation and dimensions of vertically extending supports 102 and channels 208 are sufficient to hold trellis 100 or 100′ in an assembled configuration, i.e. to retain bracket 200 in place atop vertically extending supports 102 which remain in their generally vertical orientation. Because vertically extending supports 102 are slideably received within channels 208, and as long as at least three vertically extending supports 102 are used to provide a reasonable degree of lateral stability, trellis 100 or 100′ is freestanding. For example, the dimensions of channels 208 may be only slightly greater than or even slightly smaller than the external cross-sectional dimensions of vertically extending supports 102, so that vertically extending supports 102 are relatively snugly received within channels 208.

To provide additional strength to trellis 100 or 100′, in some embodiments bracket 200 is secured in place on vertically extending supports 102 using additional fasteners such as nails or screws, application of a suitable adhesive, or the like.

In the illustrated embodiment, to facilitate the insertion of fasteners through bracket 200, housing 202 is provided with surface features that allow for the facile passage of fasteners through the material of housing 202. In the illustrated embodiment, such surface features are a plurality of dimples 220. Dimples 220 facilitate the passage of a fastener such as a nail or screw through the material from which housing 202 is made without damaging housing 202. In some embodiments, a user drills apertures at the location of dimples 220 to further facilitate the passage of a fastener through housing 202 without damaging housing 202. In alternative embodiments, instead of dimples 220, housing 202 could be provided with pre-drilled apertures as the surface features allowing facile passage of fasteners. In still further embodiments, housing 202 could be provided without any kind of dimples or surface feature, and instead a user could drill through the material of housing 202 at any desired location prior to passing fasteners therethrough, to minimize a risk of damage to the material of housing 202.

In the illustrated embodiment, housing 202 is provided with eight dimples, so that up to two fasteners may be used to secure each one of vertically extending supports 102 in place. In alternative embodiments, any desired number of dimples could be provided and used, e.g. 1, 2, 3, 4, 5, 6, 7, 8, 9, 10, 11, 12, 13, 14, 15, 16 or more dimples, to facilitate the use of more or fewer fasteners as desired.

In the illustrated embodiment, if a user elects not to use fasteners or other securement mechanisms to hold vertically extending supports 102 within bracket 200, dimples 220 provide a small piece of inwardly extending material that can bite into and slightly further secure vertically extending supports 102 within bracket 200.

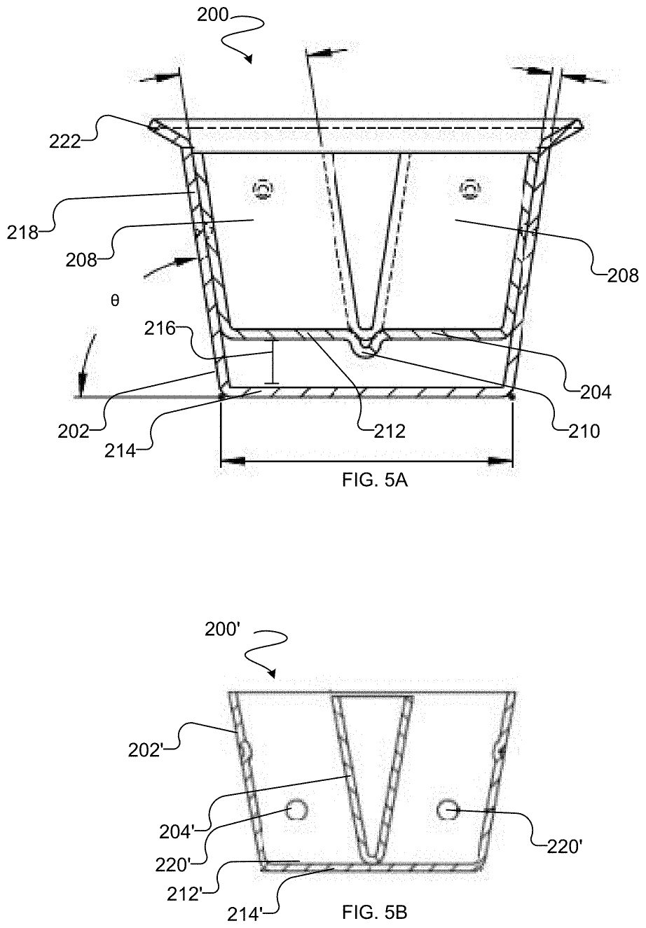

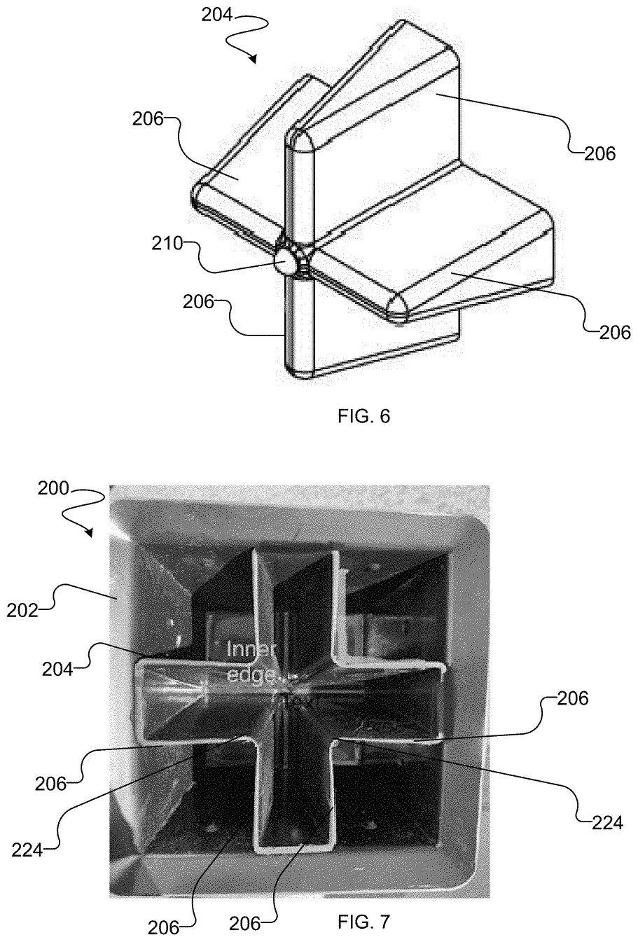

With reference to FIGS. 5A and 6, in the illustrated embodiment, a top surface 212 of internal support 204 that is oriented towards the top portion 214 of housing 202 is provided with a protrusion 210. Protrusion 210 helps to ensure that a space 216 remains between top surface 212 and the top portion 214 of housing 202, which may be desirable for maintaining certain proportions of bracket 200 (e.g. to make the top portion of the housing of a suitable dimension for receiving a decorative post cap while still fully receiving the vertically extending supports 102) and which facilitates the easy assembly of bracket 200 with internal support 204 consistently positioned at the correct position within housing 202.

In some embodiments, illustrated as bracket 200′ in FIG. 5B, protrusion 210 is omitted and top surface 212′ of internal support 204′ directly contacts the top portion 214′ of housing 202′. Also, instead of dimples 220, bracket 200′ is provided with pre-drilled apertures 220′.

In some embodiments where trellis 100 serves as a support for growing plants, an external angle θ (FIG. 5A) of a sidewall 218 of housing 202 relative to a plane defined by top portion 214 of housing 202 is between about 80° to 82°, including any value therebetween e.g. 80.1, 80.2, 80.3, 80.4, 80.5, 80.6, 80.7, 80.8, 80.9, 81.0, 81.1, 81.2, 81.3, 81.4, 81.5, 81.6, 81.7, 81.8, or 81.9°. Such a value for angle θ provides a trellis structure 100 in which the walls are not too steeply vertical (e.g. in the nature of a vertical tower that would be provided in embodiments in which angle θ is 90°), and also in which the base of a relatively tall trellis structure (e.g. 4′, 5′ or 6′ in height) remains reasonably compact (e.g. remains within a 2′ by 2′ space). In alternative embodiments, other angles could be used for angle θ as desired, including any angle between about 60° and about 90°, e.g. 65, 70, 75, 80 or 85°.

In embodiments in which vertically extending supports 102 have a square or rectangular cross-section, the external angle formed by support arms 206 relative to the plane defined by top portion 214 of housing 202 should be the same as angle θ, so that the ends of vertically extending supports 102 can be inserted into and retained within channels 208. That is, support arms 206 extend generally parallel to sidewall 218 of housing 202.

In the illustrated embodiment, housing 202 is provided with an outwardly extending flange 222. Outwardly extending flange 222 helps to strengthen and support housing 202 and maintain the structural integrity of the vertically extending structure made using bracket 200. In some embodiments, e.g. as illustrated in FIG. 5B, outwardly extending flange 222 is omitted.

In some embodiments, support arms 206 are resilient, i.e. are capable of deformation and then returning to their original shape. This allows support arms to be deformed slightly away from vertically extending supports 102 as the vertically extending supports 102 are inserted into bracket 200, and then to return to their original shape, thus slightly gripping or supporting vertically extending supports 102.

As illustrated in FIG. 7, in some embodiments depending on the mode of manufacture of internal support 204, the inner edges 224 of internal support 204 that form the corners between adjacent support arms 206 are formed of slightly thinner material than support arms 206. This can allow for increased deflection of support arms 206 when vertically extending supports 102 are being inserted into channels 208. For example, in one example embodiment in which internal support 204 and housing 202 are made from 0.118″ ABS haircell plastic which is stretched over a mold, the thickness of the plastic material forming internal support 204 is approximately 0.1″ at connection points 205 but only 0.045″ at the inner edges 224, and the thickness of housing 202 at outwardly extending flange 222 is approximately 0.08″ to 0.09″. Internal support 204 is thus rigid at the point where it is affixed to the internal surface of housing 202 at connection points 205, but flexible and resilient along support arms 206 and through inner edges 224.

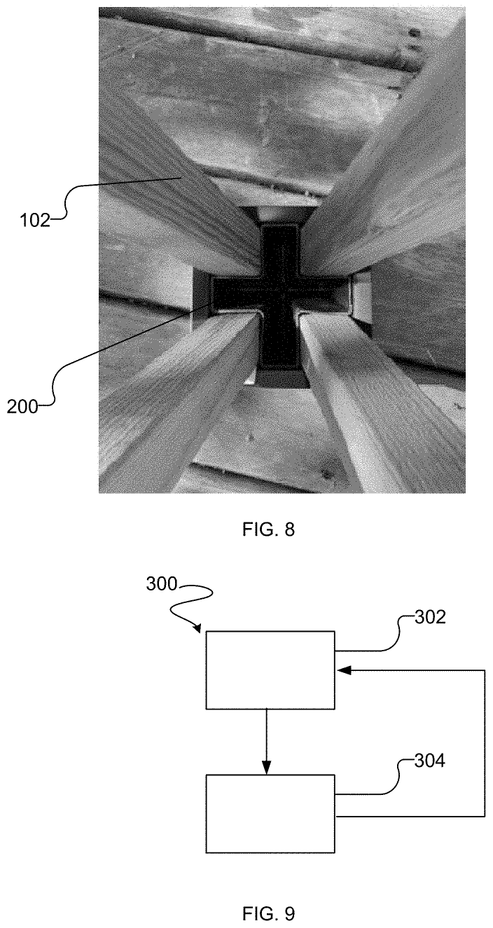

With reference to FIG. 8, free ends of a plurality of vertically extending supports 102 that are pieces of lumber are illustrated inserted in channels 208 of bracket 200. As can be seen, the outer surface area of vertically extending supports 102 is snugly engaged by support arms 206, so that vertically extending supports 102 are gently held in place within bracket 200.

In some embodiments, a method 300 of assembling a vertical structure is provided, as illustrated in FIG. 9. The method includes at step 302 taking a free end of each one of the vertically extending supports 102 and at 304 inserting such free end into a corresponding channel 208 of bracket 200. Steps 302 and 304 can be repeated until each one of the vertically extending supports 102 has been inserted into a corresponding channel 208 of bracket 200 to form a vertical structure such as trellis 100 or 100′. In some embodiments, the vertical structure is a trellis or an obelisk.

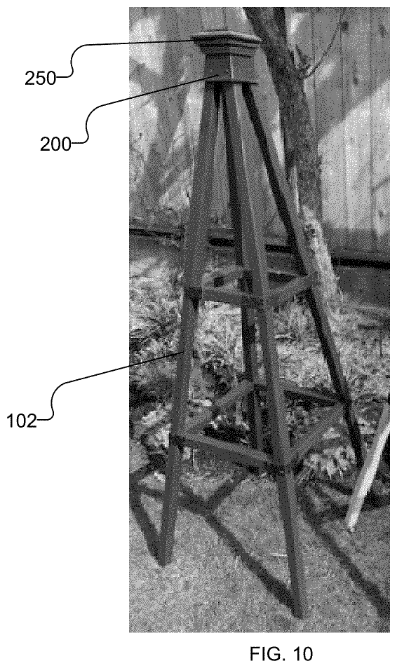

Bracket 200 may be made from any suitable material, including metal, plastic or the like and in any suitable manner. In some embodiments, bracket 200 is made from acrylonitrile butadiene styrene (ABS) plastic, e.g. ABS black haircell plastic. Bracket 200 may be made in any desired dimensions. For example, in some embodiments intended for use to secure standard pieces of lumber, bracket 200 has dimensions of 3½″ across its top and approximately 5¼″ across its base. In some embodiments, bracket 200′ has dimensions of 3¾″ across its top. In some embodiments, the dimensions of the bracket are selected so that any type of decorative post cap or lighting fixture suited for attachment to a conventional 4×4 post can be secured atop the bracket, illustrated as decorative post cap 250 in FIG. 10. Bracket 200 may be manufactured in any desired manner, e.g. by hand, by injection molding, by vacuum molding, or the like.

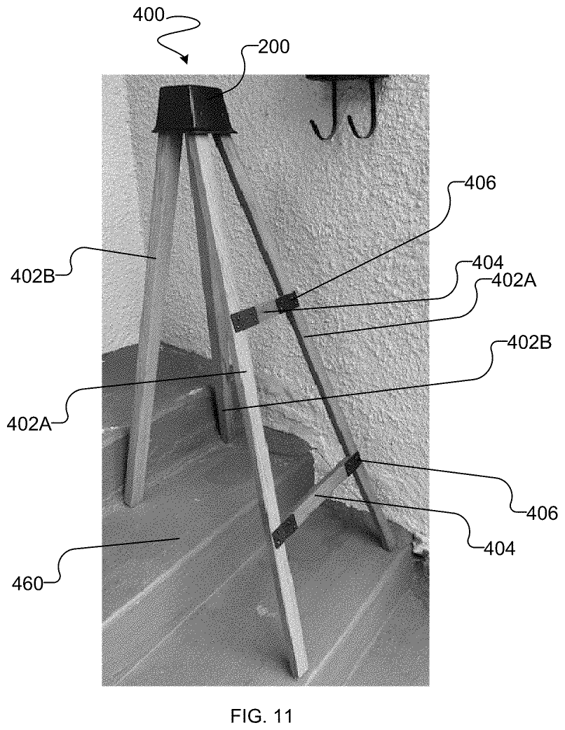

In various embodiments, various modifications may be made to the components described herein. For example, with reference to FIG. 11, an example embodiment of a trellis 400 is illustrated that has vertically extending supports that are of different lengths, so that trellis 400 can sit on steps 460 or other vertically uneven terrain (e.g. a hillside, slope or the like). Specifically, trellis 400 is still assembled using a bracket 200 as described herein, but has a first pair of vertically extending supports 402A that are of a first length, and then a second pair of vertically extending supports 402B that are shorter in length than the first length, so that trellis 400 can be situated on a step or other vertically uneven terrain. In a similar manner, the lengths of any or all of the vertically extending supports could be varied in any other desired manner, to accommodate any sort of rough or uneven terrain (e.g. only one of the vertically extending supports could be shorter than the rest, three could be shorter than a fourth, each one could have a different length, and so on).

Also in trellis 400, and by way of example only, two 1×2 pieces of dimensional lumber are used to provide longer vertically extending supports 402A, while two 2×2 pieces of lumber are used to provide shorter vertically extending supports 402B.

Furthermore, through the use and configuration of appropriate horizontal supports 404 secured in place using side brackets 406, the footprint or positioning of any of the vertically extending supports can be adjusted—e.g. as for vertically extending supports 402A in the illustrated embodiment of FIG. 11. The horizontal supports 404 can be made longer or shorter to respectively “push” vertically extending supports 402A farther apart or “pull” vertically extending supports 402A closer together. There is some amount of flexibility for the vertically extending supports secured within bracket 200 to tilt slightly, so that the footprint of the trellis (more specifically, the positioning of each one of the vertically extending supports where it contacts the ground or other structure on which the trellis sits) can be adjusted to some degree via the forces applied on the vertically extending supports by the horizontal supports.

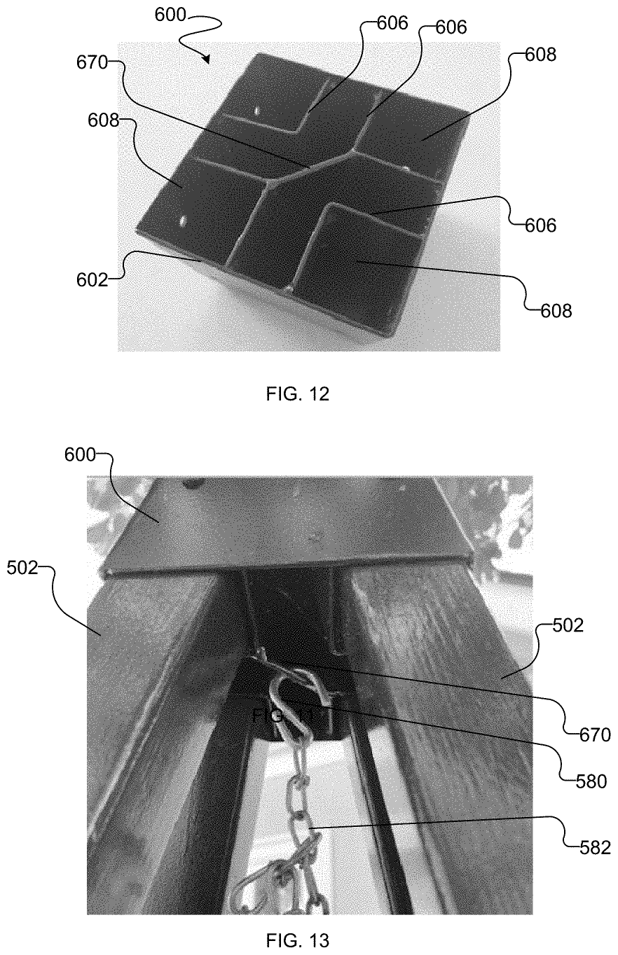

With reference to FIGS. 12 and 13, in some embodiments a connector can be affixed between the support arms of the bracket, to support a structure hanging vertically downwardly from the bracket when in use. For example, a bracket 600 has a housing 602 and a plurality of support arms 606 defining channels 608 for receiving the vertically extending supports. A support bar 670, being a portion of material extending between two of the support arms 606 to extend through a central portion of housing 602, is provided. As shown in FIG. 13, when bracket 600 is used to support a plurality of vertically extending supports 502, support bar 670 can be used to secure any component that it is desired to support within the structure formed using bracket 600. In the illustrated embodiment, support bar 670 is used to support a hanger 580 of a chain 582, which in turn supports a hanging basket containing plants within the structure. Any desired item could be suspended from support bar 670 in a similar manner, for example a hanging basket or planter, water bag, bird feeder, bird house, wind chimes, lights, netting, covers for young plants, or any other decorative or functional object as may be desired.

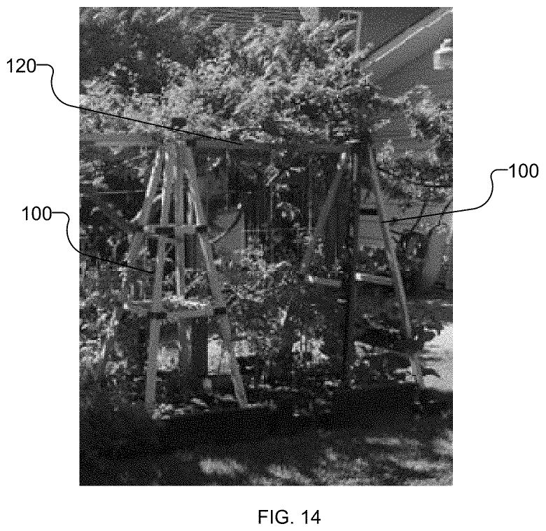

With reference to FIG. 14, if desired, two or more trellises 100 can be coupled together in any desired manner to form more complex structures. For example, in the embodiment illustrated in FIG. 14, two trellises 100 have been connected by a horizontal support 120 to provide a support for growing plants. Horizontal support could be used in any desired manner to support any desired object between the two adjacent trellises 100, and multiple adjacent trellises 100 could be interconnected in a similar manner if desired.

Any reference to a trellis or other assembled vertical structure used herein can be applied to a trellis or other vertical assembled structure according to any other embodiment. Various features of the various embodiments described herein can be combined together in different combinations to yield additional embodiments. The trellis or assembled structure as described herein can have a plurality of potential uses limited only by the imagination of the end user. For example, the trellis or assembled structure can be used as a trellis or obelisk, as a plant support, for decorative purposes, as a support for shelving if used with horizontal supports and one or more horizontal shelves, as a support for plant growing shelves, whether exposed to the elements or as a miniature greenhouse if used in conjunction with a suitable cover, as an indoor or outdoor plant stand, as a freestanding towel, clothing or accessory rack, as an optionally transportable retail display unit (e.g. if shelving and/or pegs are added to the vertically extending supports to hang items of merchandise) for example for use at farmers markets or the like where non-permanent displays or kiosks are used since the structure is easily transportable, as supports for patio lights or other outdoor lighting, as a freestanding support for flowers or other decorative displays where no other supports exist (e.g. for use at weddings or parties), as freestanding supports to create a walk through arbor, or the like.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A bracket for supporting a plurality of vertically extending supports, the bracket comprising:
an outer housing; and
an internal support;
the internal support being receivable within the outer housing and the outer housing and the internal support together defining a plurality of channels, each one of the plurality of channels being shaped and configured to receive a free end of a corresponding one of the plurality of vertically extending supports.

2. A bracket as defined in claim 1, wherein the outer housing comprises a generally cubic shape having a top portion and four sidewalls depending from the top portion.

3. A bracket as defined in claim 2, wherein the outer housing comprises an outwardly extending flange extending outwardly from each one of the sidewalls, wherein the outwardly extending flange is provided at an end of the outer housing opposite the top portion.

4. A bracket as defined in claim 3, wherein the internal support comprises a plurality of support arms, each adjacent pair of support arms together with an internal surface of the outer housing defining one of the plurality of channels.

5. A bracket as defined in claim 4, wherein each one of the plurality of support arms extends in a plane parallel to a plane defined by an opposed sidewall of the outer housing.

6. A bracket as defined in claim 5, wherein an external angle of a sidewall of the outer housing relative to a plane defined by a top portion of the housing is between about 80° and about 82°.

7. A bracket as defined in claim 1, wherein the support arms are resilient.

8. A bracket as defined in claim 1, wherein each pair of adjacent support arms is joined by an inner edge.

9. A bracket as defined in claim 8, wherein a thickness of the material forming the internal support is less at the inner edge than a thickness of the material forming the internal support at both of the support arms and the connection points.

10. A bracket as defined in claim 1, wherein a top surface of the internal support is provided with a protrusion that is oriented towards a top portion of the outer housing when the internal support is inserted within the outer housing.

11. A bracket as defined in claim 1, wherein the internal support comprises a plurality of connection points, each one of the plurality of connection points being positioned between an adjacent pair of support arms.

12. A bracket as defined in claim 11, wherein each one of the connection points is secured to an inner surface of the outer housing.

13. A bracket for supporting a plurality of vertically extending supports, the bracket comprising a plurality of channels, each one of the plurality of channels being shaped and configured to receive a free end of a corresponding one of the plurality of vertically extending supports.

14. A bracket as defined in claim 1, comprising a support bar positioned internally of the channels, wherein the support bar extends between two of the support arms.

15. A vertical structure comprising:
a plurality of vertically extending supports; and
a bracket as defined in claim 1, a free end of each one of the vertically extending supports being received in a corresponding channel of the bracket.

16. A vertical structure as defined in claim 15, wherein each one of the plurality of vertically extending supports has a length that is the same as a length of each of the other of the plurality of vertically extending supports, or wherein at least one of the plurality of vertically extending supports has a length that is different than a length of the other of the plurality of vertically extending supports.

17. A vertical structure as defined in claim 15, further comprising at least one horizontal support connecting two adjacent vertically extending supports, wherein the at least one horizontal support is secured to apply either an inward or an outward force on the two adjacent vertically extending supports.

18. The vertical structure or method as defined in claim 15, wherein the vertical structure comprises a trellis or an obelisk.

19. The vertical structure as defined in claim 15, further comprising a decorative post cap and/or a lighting fixture adapted to be secured on a post cap.

20. The vertical structure as defined in claim 15, wherein the bracket comprises a bracket having a support bar positioned internally of the channels for supporting a hanging object within the vertical structure.
